(19) United States
(12) Patent Application Publication
(10) Pub. No.: US 2007/0285887 A1
(43) Pub. Date: Dec. 13, 2007

(54) Multimedia heat sink device

(76) Inventor: I-Chun Chang, Taoyuan city (TW)

Correspondence Address: TROXELL LAW OFFICE PLLC, SUITE 1404, 5205 LEESBURG PIKE, FALLS CHURCH, VA, 22041, US

(21) Appl. No.: 11/449,715

(22) Filed: Jun. 9, 2006

(51) Int. Cl. G06F 1/20

(52) U.S. Cl. 361/687; 361/686

(57) ABSTRACT

A multimedia heat sink device is primarily constituted by a casing, a fan, a multimedia device, and a hub. When electronic equipment is emplaced on the casing of heat sink for heat dissipation, a digital/analog TV channel can be played by the electronic equipment, through the installation of multimedia device. Furthermore, a data transmission between the electronic equipment and a peripheral electronic product can be performed through the hub, by connecting the slot of hub with the electronic product through a data line.

### BACKGROUND OF THE INVENTION

(a) Field of the Invention

The present invention relates to a multimedia heat sink device, and more particularly to a heat dissipating device which is provided with a function of playing digital/analog TV (Television) signals and a function of hub

(b) Description of the Prior Art

An ordinary conventional heat sink can only provide for a heat dissipating to electronic equipment. Therefore, if a user needs to watch a TV channel, a TV adapter should be connected additionally, and, if the user needs to proceed with an operation such as printing, scanning, or transmitting data, through the electronic equipment, a hub should be connected additionally. Accordingly, a space will be occupied, an inconvenience will be increased upon carrying the heat sink, and a trouble of connection will be incurred while using the heat sink.

Accordingly, how to eliminate the aforementioned problems is a technical issue to be solved by the present inventor.

### SUMMARY OF THE INVENTION

The primary object of present invention is to provide a multimedia heat sink device, and more particularly to a heat dissipating device which is provided with a function of playing digital/analog TV signals and a function of hub, wherein when electronic equipment is emplaced on a casing of heat sink for heat dissipation, the digital/analog TV channel can be played by the electronic equipment through an installation of multimedia device, and a data transmission can be performed between the electronic equipment and a peripheral electronic product through a hub, by connecting a slot of hub with the electronic product through a data line.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows a block diagram of an embodient of the present invention.

FIG. 3 shows a schematic view of an embodient of the present invention.

FIG. 4 shows a schematic view of a second embodient of the present invention.

FIG. 5 shows a schematic view of a third embodient of the present invention.

FIG. 6 shows a schematic view of a fourth embodient of the present invention.

FIG. 7 shows a schematic view of a fifth embodient of the present invention.

### DETAILED DESCRIPTION OF THE PREFERRED EMBODIMENTS

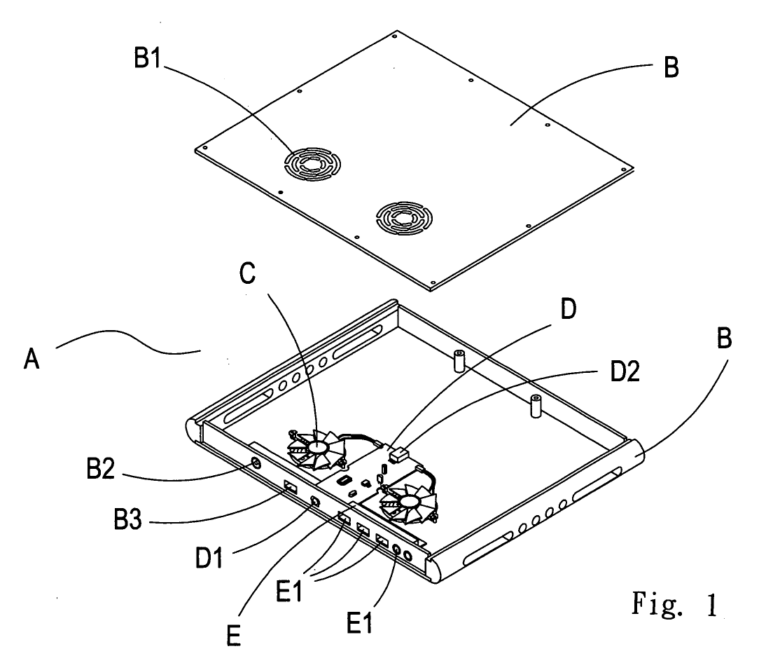

Referring to FIG. 1, a heat sink A is primarily composed of a casing B, one or more than one fan C, a multimedia device D, and a hub E.

A ventilation opening B1 is located on the casing B, at a position corresponding to the fan C, and the casing B is also provided with a power slot B2 to be conducted with the fan C, the multimedia device D, and the hub E, wherein a receiving end D1 of the multimedia device D is protruded out at one side of the casing B, an output end D2 of the multimedia device D is conducted with an insertion slot B3 installed in the casing B, and the hub E is provided with a plurality of slots E1 installed at one side of the casing B.

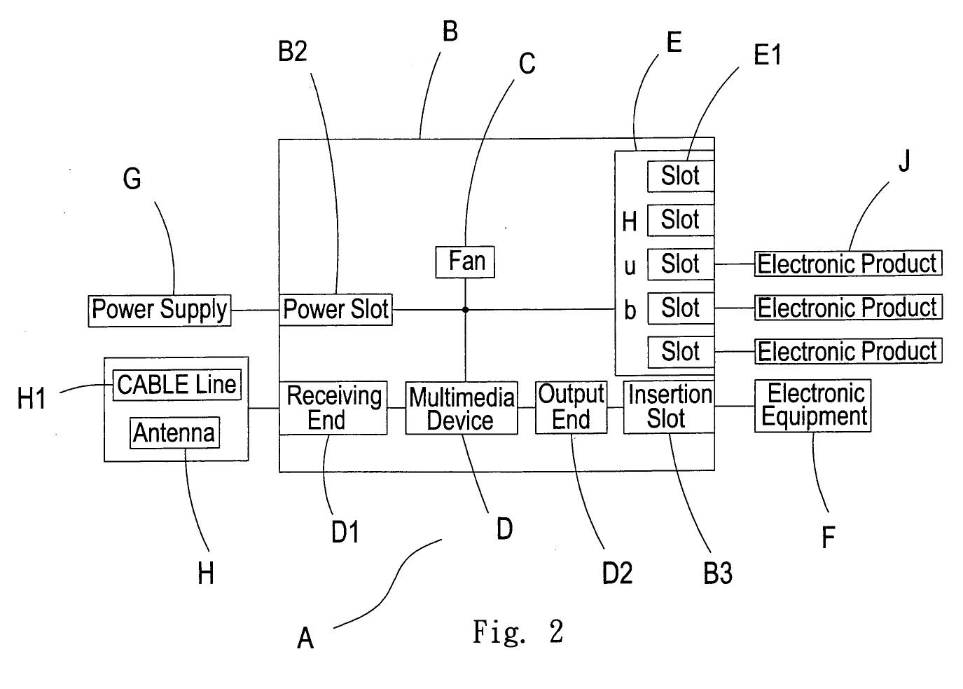

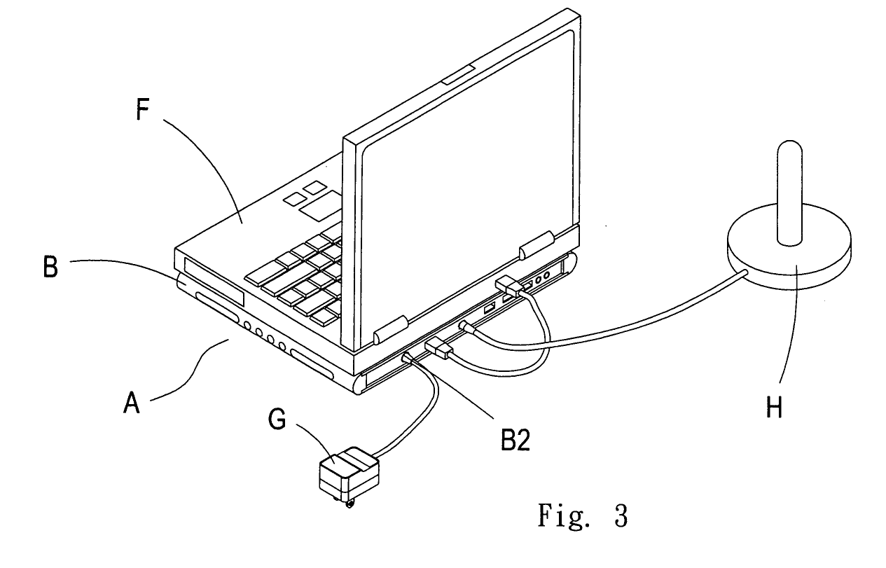

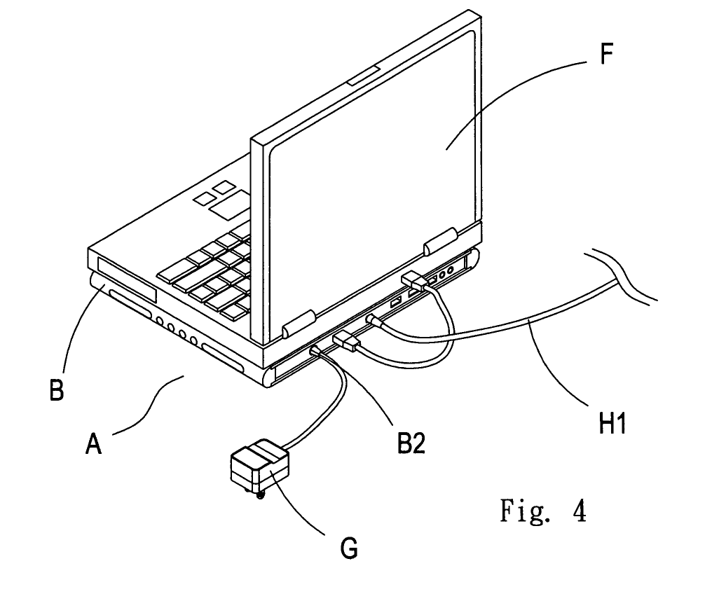

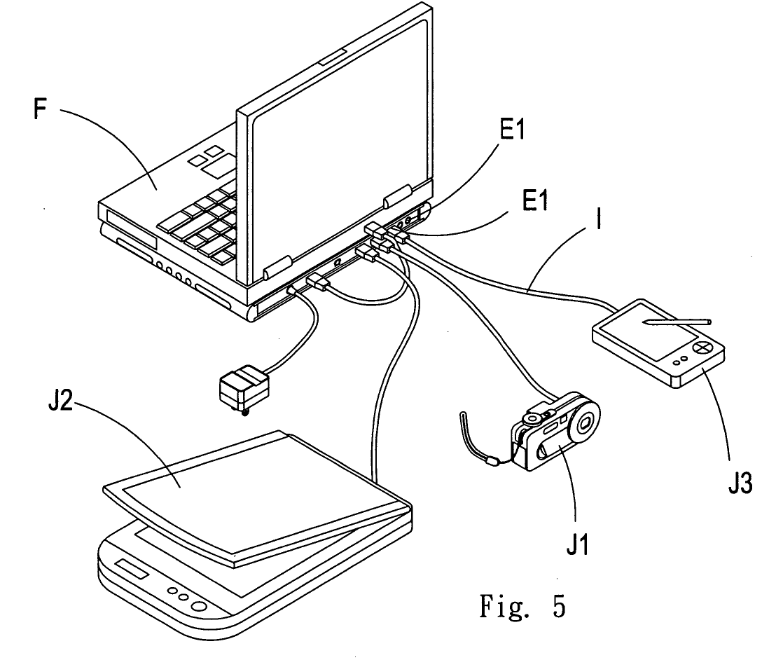

Referring to FIGS. 2 to 5, electronic equipment F is emplaced on a casing B of heat sink A for heat dissipation, and a power supply G is inserted into a power slot B2 to provide electricity required by the heat sink A. A multimedia device D inside the casing B can be used to receive a digital video signal through an antenna H connected to a receiving end D1, followed by performing a modulation/demodulation to the signal, and transmitting it to the electronic equipment F from an output end D2, such that a digital TV channel can be played by the electronic equipment F. Similarly, the receiving end D1 can be also connected with a cable line H1 to receive an analog video signal, such that an analog TV channel can be played by the electronic equipment F.

Moreover, a plurality of electronic products J can be connected to a plurality of slots E1 of a hub E through a data line 1, such that a data transmission can be performed between the electronic equipment F and the plural electronic products J through the hub E.

The electronic equipment F can be further a notebook computer, a game machine, a palm player, or other multimedia equipment which can generate heat, whereas the electronic products J can be further a digital camera J1, a scanner J2, a PDA (Personal Digital Assistant) J3, a printer, a hand-held communication equipment, and other related electronic product.

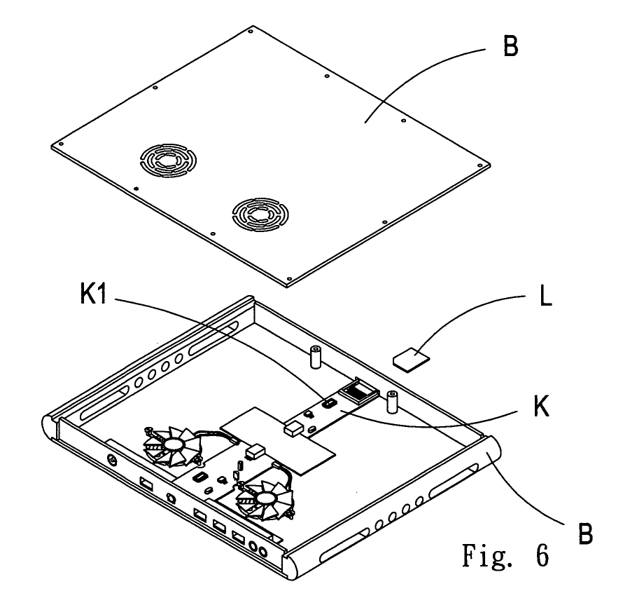

Referring to FIG. 6, the casing B is further provided with a reading device K to allow a user to insert a memory device L for performing a data access operation. In addition, the reading device K is provided with an MP3 processor K1, so as to process an operation related to a format of MP3 file.

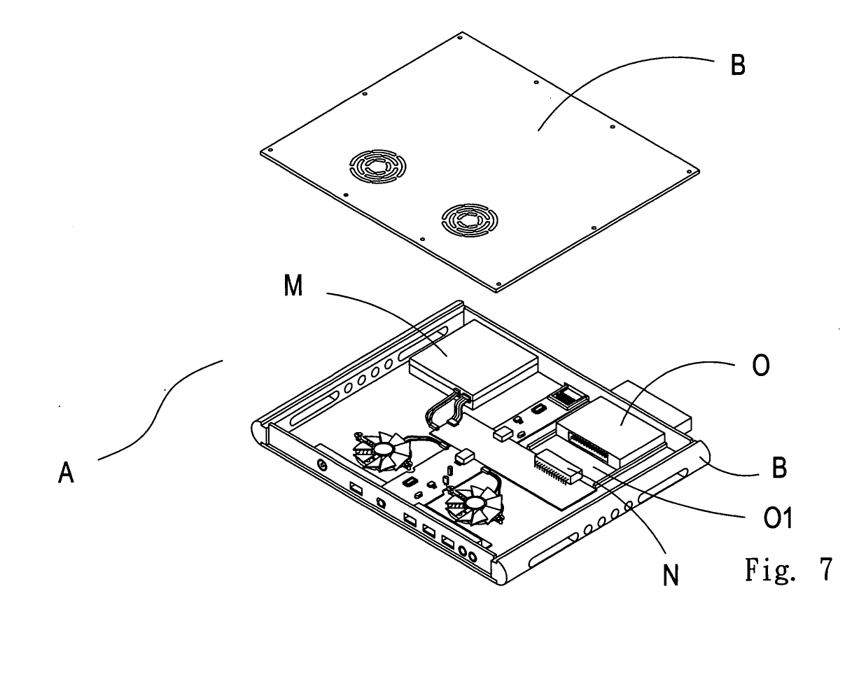

Referring to FIG. 7, the casing B further includes a CD-ROM burner M to allow the user to perform a reading and burning of CD through the heat sink A. In addition, the casing B is further provided with an IDE (Integrated Device Electronics) interface N to allow the user to insert an external hard disk drive 0 from a slide rail 01 of casing B, to perform a data access operation.

To further manifest the advancement and practicability of the present invention, the present invention is compared with a conventional heat sink as follows:

Shortcomings of a conventional heat sink

1. It will occupy a space.

2. It is inconvenient to carry.

3. It will cause a trouble of insertion while using the heat sink.

Advantages of the present invention

1. It can greatly save a space of utilization.

2. It can increase a convenience to carry.

3. It is easy for insertion.

4. It can increase efficiency of utilization.

5. It is provided with advancement and practicability.

6. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multimedia heat sink device comprising at least a casing which is provided with one or more than one fan, a multimedia device which is installed with a receiving end and an output end, and a hub which is installed with a plurality of slots; the casing providing for electronic equipment to be emplaced on it for heat dissipation, and a video signal being received through the receiving end of multimedia device, enabling the electronic equipment to play a TV (Television) channel, whereas the plural slots of hub providing for a connection to other electronic products, so as to achieve an object of multitasking.

2. The multimedia heat sink device according to claim 1, wherein a ventilation opening is located on the casing, at a position corresponding to the fan, so as to expel out a heat source of casing through the ventilation opening, using a wind power generated by the fan.

3. The multimedia heat sink device according to claim 1, wherein the casing is further provided with an insertion slot and a power slot, the insertion slot is connected to the output end of multimedia device and to the hub, and the power slot is connected to a power supply for supplying electricity required by the casing.

4. The multimedia heat sink device according to claim 1, wherein the receiving end provides for an insertion of antenna, so as to receive a digital video signal.

5. The multimedia heat sink device according to claim 1, wherein the receiving end provides for an insertion of cable line, so as to receive an analog video signal.

6. The multimedia heat sink device according to claim 1, wherein the output end is able to output the video signal after being modulated and demodulated by the multimedia device, to the electronic equipment, so as to enable the electronic equipment to play a TV channel.

7. The multimedia heat sink device according to claim 1, wherein the electronic equipment is a notebook computer, a game machine, a palm player, and other related multimedia equipment which can generate heat.

8. The multimedia heat sink device according to claim 1, wherein the electronic product is a printer, a scanner, a digital camera, a hand-held communication equipment, a PDA (Personal Digital Assistant), and other related electronic product.

9. The multimedia heat sink device according to claim 1, wherein the slot installed with the hub can be further an interface slot for a USB (Universal Serial Bus), an audio output, and an audio input device.

10. The multimedia heat sink device according to claim 1, wherein the casing further includes a reading device to provide for an insertion and data accessing of a memory device.

11. The multimedia heat sink device according to claim 10, wherein the memory device is a CF (Compact Flash Memory Card) card, a Duo-MS (Duo Memory Stick Memory Card) card, an MS (Memory Stick Memory Card) card, an MGMS (Magic Gate Memory Stick Memory Card) card, a Mini SD (Mini Secure Digital Memory Card) card, an MMC (Multimedia Memory Card) card, a Pro-MS (Pro Memory Stick Memory Card) card, a RSMMC (Reduced Size Multimedia Memory Card) card, an SD (Secure Digital Memory Card) card, an SM (Smart Memory Card) card, a Type-I CF card, a Type-II CF card, and an Xd (extreme Digital Picture Memory Card) card.

12. The multimedia heat sink device according to claim 10, wherein the reading device is further installed with an MP3 processor to perform an operation related to a format of MP3 (MPEG Audio Layer III) file.

13. The multimedia heat sink device according to claim 1, wherein the casing is further provided with a CD-ROM (Compact Disc Read-Only Memory) burner, such that a reading and burning of CD (Compact Disc) can be performed by the electronic equipment through the heat sink.

14. The multimedia heat sink device according to claim 1, wherein the casing is further provided with an IDE (Integrated Device Electronics) interface, to provide for an insertion of an external hard disk, thereby facilitating the electronic equipment to perform a data access operation of external hard disk through the heat sink.
